(19) United States
(12) Patent Application Publication
(10) Pub. No.: US 2003/0123442 A1
(43) Pub. Date: Jul. 3, 2003

(54) Distributed usage metering of multiple networked devices

(76) Inventors: Benjamin T. Drucker, San Francisco, CA (US); Albert Y. Teng, Cupertino, CA (US)

Correspondence Address: TROP PRUNER & HU, PC, 8554 KATY FREEWAY, SUITE 100, HOUSTON, TX, 77024, US

(21) Appl. No.: 10/034,955

(22) Filed: Dec. 27, 2001

(51) Int. Cl. H04L 12/28; H04L 12/56

(52) U.S. Cl. 370/392; 370/471

(57) ABSTRACT

Distributed usage metering of network packet traffic, requiring fewer metering devices than ultra-fine-grain metering, more scalable than centralized metering, and providing weighted packet history analysis on various packet characteristics, with redefineable weight definitions.

### BACKGROUND OF THE INVENTION

1. Technical Field of the Invention

The present invention relates generally to networking services, and particularly to a metering device for such.

2. Background Art

Network service providers desire to meter usage of their networks and servers, in order to provide load balancing, prevent fraud, enable accurate billing, and so forth. To date, there are two known metering models: ultra-fine-grain (UFG) and centralized.

FIG. 1 illustrates a system 10 employing a UFG metering system. Each of the numerous customers 12 such as residences or businesses has a network device 14 which generates and receives network traffic. In some systems, these network devices may be personal computers, cable television set-top boxes, or any other network devices. In the UFG model, each customer is provided with a metering device 16 networked to the one or more network devices at that customer's location. The metering devices and/or network devices are networked to a central service provider server 20 over one or more networking media using one or more networking protocol.

Examples of networking media include digital subscriber line (DSL), coaxial cable, PhonePNA, HomePNA, fiber distributed data interface (FDDI), twisted pair, Ethernet wire, IEEE 802.11 wireless, Bluetooth, HFC, GPRS, 3G, satellite, and so forth. Examples of networking protocols include TCP/IP, asynchronous transfer mode (ATM), AppleTalk, Token Ring, and so forth. The service provider server may, in turn, be connected to other networks and other servers. The service provider server performs networking services, data delivery, billing, and so forth, and also gathers and collates data reported by the multitude of metering devices 16. In many cases, the service provider server may be embodied as more than one server of different types, such as a primary server, a backup server, a billing system, a firewall, a front-end, a head-end, a back-end, a provisioning server, an encryption and authentication server, and so forth.

FIG. 2 illustrates a system 22 employing a centralized metering system, in which each customer's location 12 is equipped with a networking device 14 but not a metering device. The metering is all done by the central service provider server 24.

Unfortunately, the UFG model is expensive—one metering device for each customer. Also, the service provider's server equipment must be able to deal effectively with interfacing directly to this large number of metering devices, which tends to raise the cost of the server equipment.

And, unfortunately, the centralized model does not scale well. As more and more customers are added, the server's metering workload increases at least linearly. Maintenance increases accordingly. At some point, the server equipment may simply reach the limit of its metering ability, and it will not be possible to add any new customers without replacing the server equipment with larger, more powerful, and more expensive servers.

Furthermore, existing systems apply set metering rules and a fixed number of metrics at any given time.

The U.S. patent application Ser. No. 09/811,128 filed Mar. 16, 2001 entitled “Gateway Metering and Bandwidth Management” shares a common inventor, Albert Teng, with this invention. That invention was directed to solving fraud by tracking multiple users of a single interface, by recording address ports on TCP/IP networks, for example. That invention defeated the ability of network address translation devices from hiding the true source of network traffic, which is a commonly employed fraud mechanism whereby e.g. two neighbors can both get network service while paying for only a single subscription. That invention has difficulty in certain circumstances, such as inaccurately identifying sources of network packets for applications that spawn multiple TCP sessions.

What is desirable, then, is a metering apparatus, method, and system which is both less expensive than the UFG model and more scalable than the centralized model, and which relies on hardware identifications to identify traffic sources.

### BRIEF DESCRIPTION OF THE DRAWINGS

The invention will be understood more fully from the detailed description given below and from the accompanying drawings of embodiments of the invention which, however, should not be taken to limit the invention to the specific embodiments described, but are for explanation and understanding only.

FIG. 1 illustrates an ultra-fine-grain metering system according to the prior art.

FIG. 2 illustrates a centralized metering system according to the prior art.

FIG. 3 illustrates a distributed, multi-device metering system according to one embodiment of this invention.

FIG. 4 illustrates a single-network embodiment of the metering device of this invention.

FIG. 5 illustrates a dual-network embodiment of the metering device of this invention.

FIG. 6 illustrates an embodiment of the metering device of this invention, configured to also provide hub/switch/router services.

FIG. 7 illustrates one embodiment of the metering device of this invention.

FIG. 8 illustrates one exemplary method of operation of the metering device of this invention.

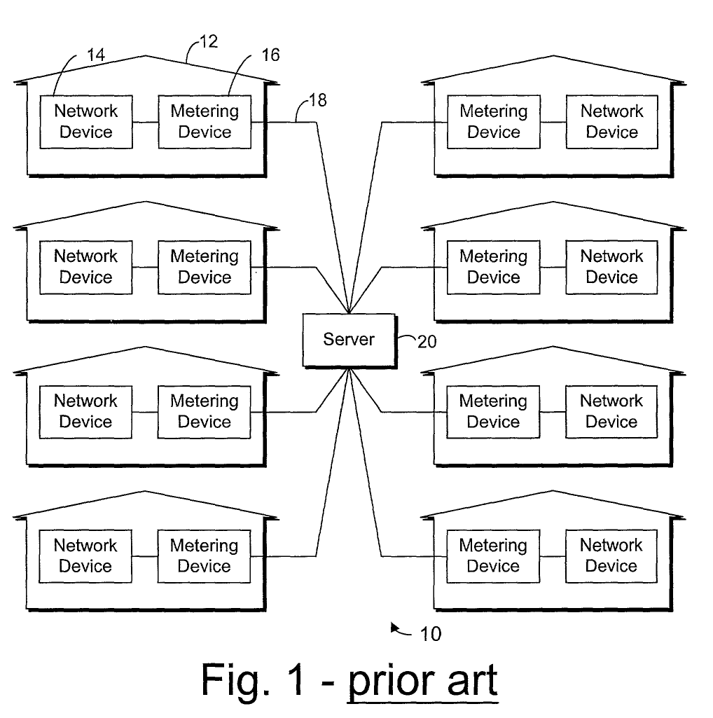

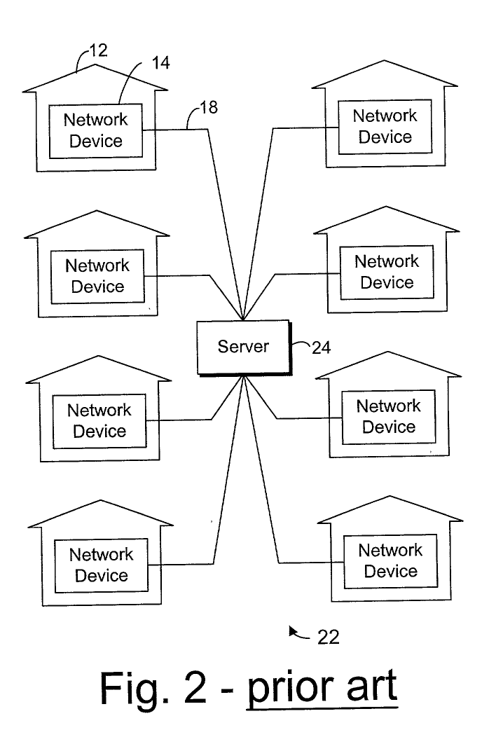

### DETAILED DESCRIPTION

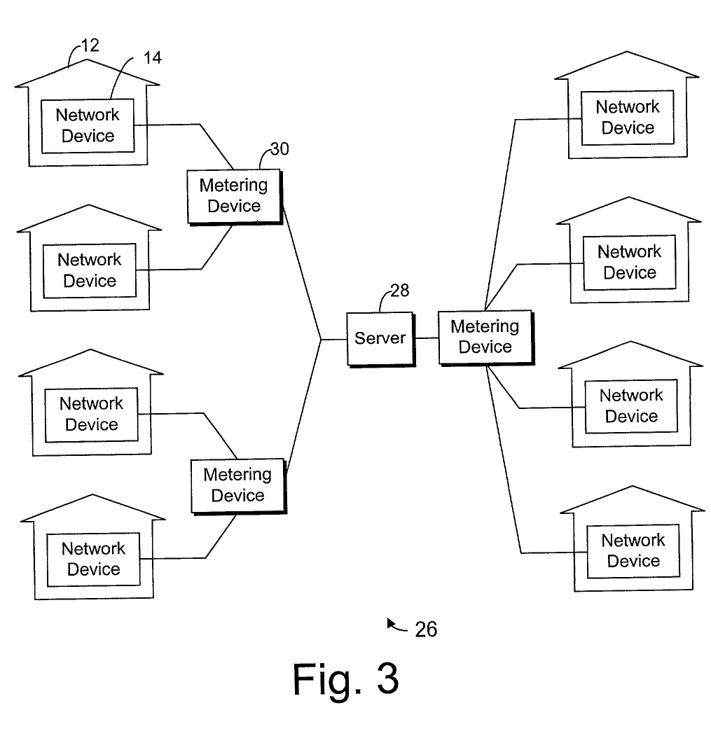

FIG. 3 shows a system 26 in which each customer 12 has one or more network devices 14 coupled over suitable network media and protocol to the service provider's server 28. Metering is provided in a distributed usage (DU) metering manner, in which the metering is performed by a plurality of metering devices 30. Each metering device can be connected to more than one customer. Thus, the DU model employs fewer metering devices than the UFG model, but more than the single metering device (server) of the centralized model.

As new users are added to the DU system,

(a) the increased metering workload placed on the server is reduced by a factor of N, as compared to the centralized model, and

(b) the increased expense of purchasing new meters is reduced by a factor of N, as compared to the UFG model,

wherein N is the number of customers connected to a DU meter 30. N may, of course, be a variable number; it is not required that each DU meter have the same number of customers.

In the UFG model, the average number of customers per metering device is 1. In the centralized model, the average number of customers per metering device will typically be in the range of 512-10,000. In the DU model, the average number of customers per metering device will typically be in the range of 2-512; more commonly, it will be in the range of 4-128; and often, it will be in the range of 8-32.

In this sense, “customers” can mean subscribing persons, or it can mean subscribing devices, or the like.

In the DU model, the DU meters perform metering services for their respective customers, and then report their data or results to the central server, which may roll the data up into a single report or calculation.

There are various connection schemes whereby a metering device may be connected to a network.

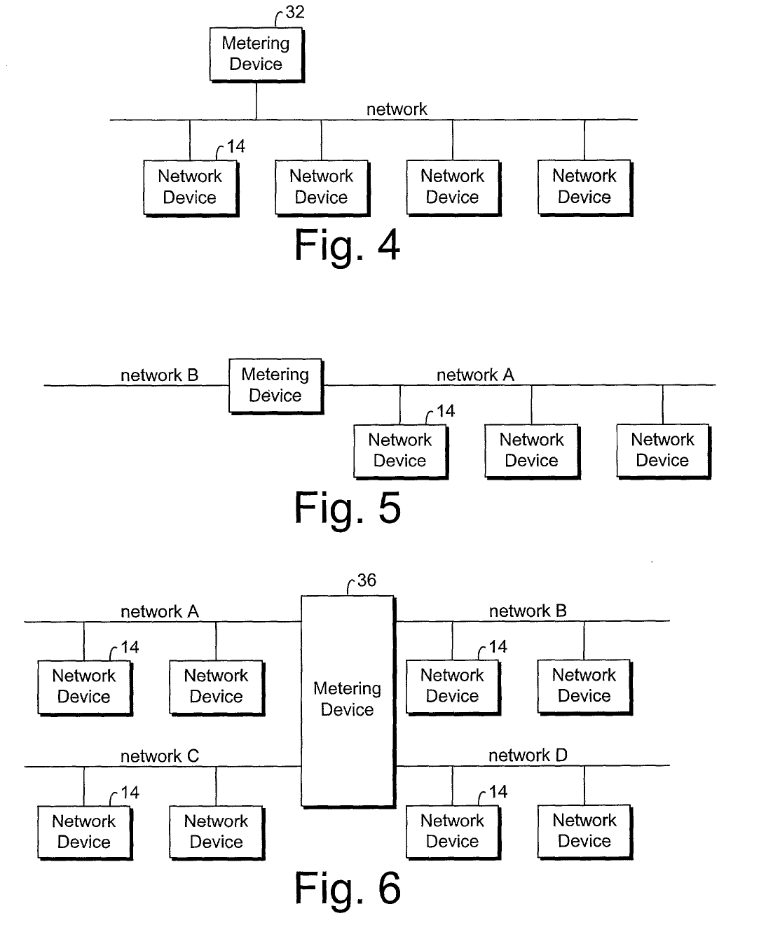

FIG. 4 shows a system in which the metering device 32 is coupled to a single network (“network”). In this embodiment, the metering device is coupled as a passive listening device, which simply monitors the network packets traveling to and from any and all of the network devices 14 which are connected to that same network.

FIG. 5 shows a system in which the metering device 34 serves as the connection point or gateway between one network (“network A”) and another network (“network B”). In this embodiment, the metering device performs both gateway and metering services for the network devices 14 connected to one of the networks (“network A”).

FIG. 6 shows a system in which the metering device 36 serves as the router or switch or hub between two or more networks (“network A” through “network D”). In this embodiment, the metering device performs both router/switch/hub and metering services for the network devices 14 coupled to each of the networks, or coupled to a subset of the networks.

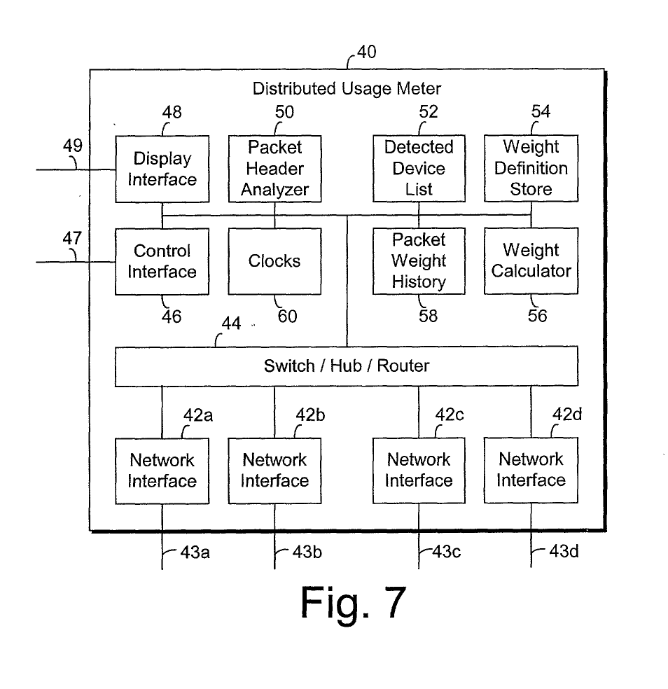

FIG. 7 shows one exemplary embodiment of a metering device 40 (“Distributed Usage Meter”) which incorporates the principles of this invention. The metering device 40 may be configured in any suitable configuration, such as one of those shown in FIGS. 4-6. The metering device includes one or more network interfaces 42a-d for connecting the network device to one or more corresponding networks 43a-d, which may use the same transport medium or different transport media, and which may use the same networking protocol or different networking protocols, as needed in the application at hand.

The metering device may in some embodiments further include a switch or hub or router mechanism 44 coupled to the network interfaces, to perform switch/hub/router functionality.

The metering device may in some embodiments also include a separate control interface 46 for sending and receiving metering control commands, signals, and data. In some embodiments, the control interface may share a same physical networking medium with one or more of the attached networks, and the metering commands etc. may be sent and received over one or more of the network interfaces, such as via the Simple Network Management Protocol (SNMP). In some embodiments, both the shared network/control interface and a dedicated control interface may be employed, such as, for example, to permit remote control via the conventional network interface and local operator control via the dedicated control interface such as from a keyboard. In some embodiments, the control interface may connect to a dedicated command link 47 which is distinct from the physical network media.

The metering device may, in some implementations, include a display interface 48 for connecting the metering device over a display link 49 to a video or other suitable display mechanism (not shown), such as for use by a local operator. In some embodiments, video and other output may instead be sent over the network interface and/or the control interface. In other embodiments, any or all of these may be present in combination.

A packet header analyzer 50 performs the basic packet identification functionalities of the metering device. The packet header analyzer may, for example, analyze each network data packet to determine the identity of the network device which sent the packet, the identity of the network device which is to receive the packet, the communication protocol used by the packet, and so forth. In some embodiments, the packet header analyzer may be built into the switch/hub/router, while in others it may be standalone logic.

Coupled to the packet header analyzer is a mechanism for maintaining a detected device list 52, which keeps track of network devices that have sent and/or received network packets. This list may be maintained in any conventional manner, such as in a table, a linked list, and so forth. The list mechanism may include memory and/or bulk storage for maintaining the list.

Also present is a memory and/or bulk storage mechanism for storing weight definitions 54. These weight definitions comprise a collection of rules, formulas, Boolean values, logical operations, or the like, for assigning or calculating a “weight” to one or more aspects of each packet analyzed by the packet header analyzer.

Characteristics by which the metering device may track packets, and per which the metering device may assign weights to those packets, include but are not limited to: communication protocol, packet size, time that the packet was sent, time that the packet was received, current average network throughput, current peak network throughput, total number of bytes transferred, total number of bytes transferred since some particular time or event, number of packets transferred that are in a given size range, traffic to or from particular addresses or ports or networks or sub-nets or network devices or categories of such, average or peak percentage of network utilization, average or peak number of TCP sessions open, average or peak traffic level of a particular protocol, percentage mixes of specified protocols among the current network traffic, or any other characteristic which the system designer deems worthy of metering.

A weight calculator 56 is coupled to the list of weight definitions, and performs the weight calculations, formulas, or the like. A packet weight history memory or storage 58 stores these weights for one, some, or all of the network devices whose packets are being analyzed.

The weight definitions may be dynamically updated, either in response to internal logic (not shown) within the metering device, or in response to an externally received control command. For example, the network service provider may find it advantageous to track and bill by data type during the day, but by byte or packet count at night. Or, the network service provider may assign heavier metering weight to video during the day than it does at night or at times when network usage falls below some predetermined threshold. The skilled reader will readily appreciate that there are numerous ways in which a dynamically alterable set of weight definitions may be advantageous, and will be able to select a dynamic alteration scheme to suit the particular needs of the network system at hand.

Similarly, it will be within the skill of the ordinary system designer to choose appropriate sizes, interfaces, speeds, protocols, and so forth, for these memories and/or bulk storage devices.

The metering device further includes one or more clock mechanisms 60, such as a real time clock, a resettable elapsed time clock, a watchdog timer, and so forth. The data output by these clocks may be used by the weight calculator in performing its weighting operations, and may prove useful elsewhere, as well.

The reader will further appreciate that the metering device shown in FIG. 7 is only by way of illustration, and that numerous differently-constructed embodiments of such devices will be appreciated in light of the teachings of this patent, when viewed in the context of designing a new metering device or a new network. Various enhancements and optional features have been omitted, for the sake of clarity.

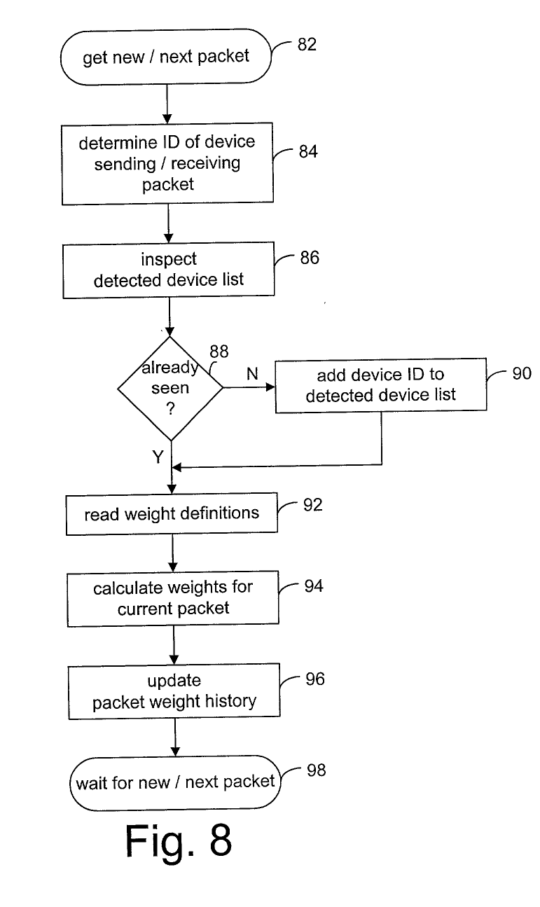

FIG. 8 illustrates one exemplary embodiment of a method (80) of operation of such a metering device. The reader may also wish to refer simultaneously to FIG. 7. Upon detection (82) of a newly-arrived packet or a next-to-be-analyzed packet, the packet header analyzer determines (84) the identity of the device sending the packet and the identity of the device receiving the packet. The metering device searches (86) the detected device list to determine whether these devices are already known to the metering device. If (88) the receiving device or the sending device has not previously been encountered (or has not been encountered since the detected device list was reset, or since that device's entry was flushed, etc.), that device is added (90) to the detected device list.

The weight calculator receives data from the packet header analyzer, regarding each of the characteristics upon which it will weight the packet, gets (92) the weight definitions from the weight definition list, and calculates (94) the respective weights for those indicated characteristics. The metering device then writes (96) these results to the packet weight history record(s) for the sending network device and/or receiving network device, as appropriate and in accordance with the weight definition rules.

The operation, initialization, resetting, flushing, and so forth of the packet weight history are very application-dependent, and will be appreciated by the skilled reader when designing the networking system in light of these teachings. In some applications, it will be desirable for the history to be maintained over a long period of time, or perhaps even in perpetuity. In other applications, it will be desirable that some or all of the history be periodically reset to start afresh. For example, in some cases it may be beneficial to track, for each network device, a total byte count sent to or from that network device since the billing period began, while resetting the percentage of network utilization metric every few minutes to allow for a more on-the-fly adjustment of bandwidth allocation.

The skilled reader will also appreciate that the ratio of network devices to metering devices is application-dependent. In various system embodiments, ratios of 2:1, 4:1, 8:1, 12:1, 15:1, other ratios may be desirable, when balancing the cost of purchasing the required number of metering devices against the cost of scaling the network servers. Furthermore, the skilled reader will readily appreciate that it is not necessary that all segments of the network have the same metering device ratio. For example, it may be found beneficial to use a different ratio for residential customers than for business customers, or a different ratio in town than in the countryside, or a different ratio in the LAN than on the WAN, and so forth.

The reader should appreciate that drawings showing methods, and the written descriptions thereof, should also be understood to illustrate machine-accessible media having recorded, encoded, or otherwise embodied therein instructions, functions, routines, control codes, firmware, software, or the like, which, when accessed, read, executed, loaded into, or otherwise utilized by a machine, will cause the machine to perform the illustrated methods. Such media may include, by way of illustration only and not limitation: magnetic, optical, magneto-optical, or other storage mechanisms, fixed or removable discs, drives, tapes, semiconductor memories, organic memories, CD-ROM, CD-R, CD-RW, DVD-ROM, DVD-R, DVD-RW, Zip, floppy, cassette, reel-to-reel, or the like. They may alternatively include down-the-wire, broadcast, or other delivery mechanisms such as Internet, local area network, wide area network, wireless, cellular, cable, laser, satellite, microwave, or other suitable carrier means, over which the instructions etc. may be delivered in the form of packets, serial data, parallel data, or other suitable format. The machine may include, by way of illustration only and not limitation: microprocessor, embedded controller, PLA, PAL, FPGA, ASIC, computer, smart card, networking equipment, or any other machine, apparatus, system, or the like which is adapted to perform functionality defined by such instructions or the like. Such drawings, written descriptions, and corresponding claims may variously be understood as representing the instructions etc. taken alone, the instructions etc. as organized in their particular packet/serial/parallel/etc. form, and/or the instructions etc. together with their storage or carrier media. The reader will further appreciate that such instructions etc. may be recorded or carried in compressed, encrypted, or otherwise encoded format without departing from the scope of this patent, even if the instructions etc. must be decrypted, decompressed, compiled, interpreted, or otherwise manipulated prior to their execution or other utilization by the machine.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the invention. The various appearances “an embodiment,” “one embodiment,” or “some embodiments” are not necessarily all referring to the same embodiments.

If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. An apparatus comprising:
at least one network interface for coupling the apparatus to at least one network;
a packet header analyzer coupled to the network interface;
a detected device list coupled to the packet header analyzer;
a weight definition store to store respective weight values for a plurality of packet characteristics;
a weight calculator coupled to the packet header analyzer and to the weight definition store; and
a packet weight history store coupled to the weight calculator.

2. The apparatus of claim 1 further comprising:
a control interface for receiving commands.

3. The apparatus of claim 2 further comprising:
the control interface being adapted to connect to a command link which is physically distinct from the at least one network.

4. The apparatus of claim 2 wherein the control interface comprises:
an SNMP interface adapted to receive SNMP commands over the least one network.

5. The apparatus of claim 1 further comprising at least one of a network switch, a network hub, and a network router.

6. The apparatus of claim 5 wherein the at least one network interface comprises at least two network interfaces.

7. A network communication system comprising:
a plurality of N network devices;
a plurality of M metering devices, wherein the ratio of M:N is in the range of 1:2 to 1:512, and wherein each metering device is coupled to at least one of the network devices; and
a server coupled to the metering devices to roll up metering reports from the metering devices.

8. The network communication system of claim 7 wherein the ratio of M:N is in the range of 1:4 to 1:128.

9. The network communication system of claim 8 wherein the ratio of M:N is in the range of 1:8 to 1:32.

10. The network communication system of claim 7 wherein at least two of the metering devices are coupled to respective different numbers of network devices.

11. The network communication system of claim 7 wherein at least some of the metering devices each comprises:
a packet header analyzer;
a detected device list coupled to the packet header analyzer; and
a packet weight history coupled to the detected device list.

12. The network communication system of claim 11 wherein the at least some of the metering devices each further comprises:
a weight definition store; and
a weight calculator coupled to the weight definition store, the packet weight history, and the packet header analyzer.

13. The network communication system of claim 12 wherein at least some of the metering devices each comprises at least one of a network switch, a network hub, and a network router.

14. The network communication system of claim 7 wherein at least some of the metering devices each comprises at least one of a network switch, a network hub, and a network router.

15. A method of operation of a metering device, the method comprising:
determining an identification of a network device sending or receiving a packet;
if the identification of the network device is not already stored in a detected device list, adding the identification of the network device to the detected device list; and
for each of at least one packet characteristic of the packet,
reading a weight definition of that packet characteristic from a weight definition store,
calculating a weight for the packet, and
updating a packet weight history.

16. The method of claim 15 wherein each of the at least one packet characteristic comprises one of:
communication protocol;
packet size;
time that the packet was sent;
time that the packet was received;
current average network throughput;
current peak network throughput;
total amount of data transferred;
total amount of data transferred since some particular time;
total amount of data transferred since some particular event;
number of packets transferred that are in a given size range;
traffic to particular addresses or ports or networks or sub-nets or network devices;
traffic from particular addresses or ports or networks or sub-nets or network devices;
average percentage of network utilization;
peak percentage of network utilization;
average number of TCP sessions open;
peak number of TCP sessions open;
average traffic level of a particular protocol;
average traffic level of a particular protocol; and
percentage mixes of specified protocols among the current network traffic.

17. The method of claim 16 further comprising:
redefining the weight definition in the weight definition store, of at least one packet characteristic.

18. A method of metering communication network traffic, the method comprising, at each of M metering devices variously coupled to respective ones of N network devices:
receiving packets from network devices;
analyzing packet headers of the packets; and
in response to the analyzing, updating a weighted packet history; wherein N>4, M>2, and M:N is in the range of 1:4 to 1:128.

19. The method of claim 18 further comprising:
rolling up metering reports from the M metering devices to at least one central server.

20. The method of claim 19 further comprising:
for each of at least one packet characteristic identified in the analyzing for a packet,
determining a weight definition for that packet characteristic,
calculating a weight for the packet, and
using the calculated weight in the updating of the weighted packet history.

21. The method of claim 20 wherein each of the at least one packet characteristic comprises a respective one of:
communication protocol;
packet size;
time that the packet was sent;
time that the packet was received;
current average network throughput;
current peak network throughput;
total amount of data transferred;
total amount of data transferred since some particular time;
total amount of data transferred since some particular event;
number of packets transferred that are in a given size range;
traffic to particular addresses or ports or networks or sub-nets or network devices;
traffic from particular addresses or ports or networks or sub-nets or network devices;
average percentage of network utilization;
peak percentage of network utilization;
average number of TCP sessions open;
peak number of TCP sessions open;
average traffic level of a particular protocol;
average traffic level of a particular protocol; and
percentage mixes of specified protocols among the current network traffic.

22. The method of claim 20 further comprising:
altering the weight definition in the weight definition store, of at least one packet characteristic.

23. An article of manufacture comprising:
a machine-accessible medium including data that, when accessed by a machine, cause the machine to,
analyze a packet header of a packet,
identify a first network device which sent the packet,
identify a second network device to which the packet was sent,
if the first or second network device is not already identified in a detected device list, adding the first or second network device to the detected device list,
for each of at least one packet characteristic of the packet,
calculating a weight for the packet, and
updating a packet weight history for that packet characteristic of that packet in
a packet weight history store.

24. The article of manufacture of claim 23 wherein the machine-accessible medium further includes data that cause the machine to:
reset at least some content of the packet weight history store.
